(19) United States
(12) Patent Application Publication
(10) Pub. No.: US 2007/0145203 A1
(43) Pub. Date: Jun. 28, 2007

(54) Display device

(75) Inventors: Tsuyoshi Takada, Tokyo (JP); Tomohiro Harata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, TOKYO (JP)

(21) Appl. No.: 10/547,291

(22) PCT Filed: Feb. 3, 2004
(86) PCT No.: PCT/JP04/01069

§ 371 Date: Oct. 26, 2006

(30) Foreign Application Priority Data
Mar. 5, 2003 (JP) 2003-058417

(51) Int. Cl. F16M 11/00

(52) U.S. Cl. 248/162.1

(57) ABSTRACT

A display apparatus in which a supporting structure excellent in operability and appearance is realized is provided.

A slide bracket (300) is provided to move up and down freely on a post (210) of a stand section (200), and a display panel section (100) and the slide bracket (300) are coupled together with a hinge section (310). The post (210) is provided with rack members (230A, 230B), which are meshed with gears (340A, 340B) provided on the slide bracket (300). Frictional rings (390) are provided to impart a frictional force to the rotating operation of the gears (340A, 340B) so that the slide bracket (300) stays at an arbitrary height of the post (210). Between the gears (340A, 340B) and the slide bracket (300), a spiral spring (370) is incorporated, and the spiral spring (370) is accommodated within a drum (360). The spiral spring (370) acts as a biasing force for causing the slide bracket (300) to move up through its biasing the gears (340A, 340B) to rotate.

### TECHNICAL FIELD

The present invention relates to a display apparatus having a flat display panel section and a stand section, used for peripheral equipment of, e.g., a personal computer.

### BACKGROUND ART

Conventionally, a display apparatus of this type has required a structure for supporting a display panel section so as to be adjustable to an arbitrary height and tilting angle. And various forms of stand sections therefor have been proposed.

For example, a structure has been proposed, in which a display panel section is mounted onto a guide section formed on a post of a stand section so as to be able to move up and down, and also a rack and a gear for adjusting the position of this display panel section are provided to adjust the height of the display panel section through the rotating operation of the gear (see, e.g., Patent Document 1 (Japanese Patent Application Publication No. 2001-42779 (FIG. 4)).

Further, another structure has been proposed, in which a slide section provided on a back surface of a display panel section and an arc-shaped curved surface formed on the side of a stand section are slidably disposed to hold the position of the slide section with a Conston spring, and the slide section is slid along the curved surface to adjust the angle of the display panel section (see, e.g., Patent Document 2 (Japanese Patent Application Publication No. 2000-250418 (FIG. 1)).

However, the various structures hitherto proposed have shortcomings in terms of operability, appearance, and the like. For example, in the related art disclosed in the above-mentioned Patent Document 1, it is required to adjust the height of the display panel section by operating an operation knob, which addresses a shortcoming that the operability is not satisfactory.

Further, in the related art disclosed in the above-mentioned Patent Document 2, even if position adjustments can be made by directly operating the display panel section, due to its configuration in which the slide section slides along the curved surface, adjustment operation is not smooth, and additionally, the structures of the Conston spring and the like are seen from the outside, which addresses a shortcoming that the appearance is not satisfactory.

Thus, an object of the present invention is to provide a display apparatus in which a supporting structure excellent in operability and appearance is realized.

### DISCLOSURE OF THE INVENTION

In order to achieve the above object, a display apparatus of the present invention has a flat display panel section, and a stand section that supports the above-mentioned display panel section, wherein the stand section is characterized by including: a base placed on an installation surface; a post provided to stand on the base and linearly extending substantially upwards; a rack member provided on the post in post extending direction; a slide bracket coupled to a back surface of the display panel section via a hinge section, and also coupled to the post to move up and down freely so at to be able to move up and down along the post; a gear mounted on the slide bracket and meshing with the rack member to rotate in linkage with the slide bracket moving up and down along the post; friction means for imparting frictional force to a rotating operation of the gear so as to hold the slide bracket at an arbitrary height of the post; a spiral spring having one end thereof locked to a gear side to be disposed in a state wound around a rotational center of the gear facing in a horizontal direction, and other end thereof locked to a slide bracket side so that the wound state thereof is changed in accordance with rotation of the gear to impart a biasing force to the gear in a rotating direction to cause the slide bracket to move up; and a cover body mounted onto the slide bracket or the gear to accommodate the spiral spring therein.

The display apparatus of the present invention has a structure in which a slide bracket is assembled to a post having a linear guide section to mesh a rack member provided on the post side with a gear provided on the slide bracket side, and also a spiral spring is provided between the gear and the slide bracket, wherein the spiral spring imparts a biasing force to the gear such that the gear rotates in such a direction as to cause the slide bracket to move up, and a cover body for accommodating this spiral spring therein is provided. As a result of the structure, height adjustments and tilting angle adjustments of the display panel section can be made smoothly, and hence a stand structure excellent in operability as well as appearance can be provided.

### BRIEF DESCRIPTION OF DRAWINGS

FIG. 1 is a side view showing an appearance of a display apparatus at the time of its moving up and down operation, according to an exemplary embodiment of the present invention.

FIG. 2 is a side view showing an appearance of a display apparatus at the time of its tilting operation.

FIG. 3 is a perspective view showing an internal structure of a display apparatus.

FIG. 4 is a perspective view showing an internal structure of a display apparatus.

FIG. 5 is a perspective view showing an internal structure of a display apparatus.

FIG. 6 is a plan view showing a main part of an internal structure of a display apparatus.

FIG. 7 is a horizontal cross-sectional view showing a main part of an internal structure of a display apparatus.

### BEST MODES FOR CARRYING OUT THE INVENTION

An exemplary embodiment of a display apparatus according to the present invention will be described below.

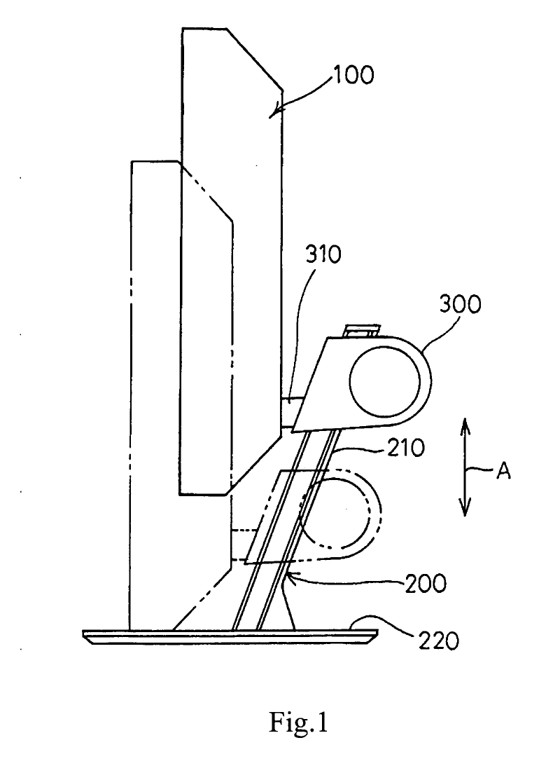

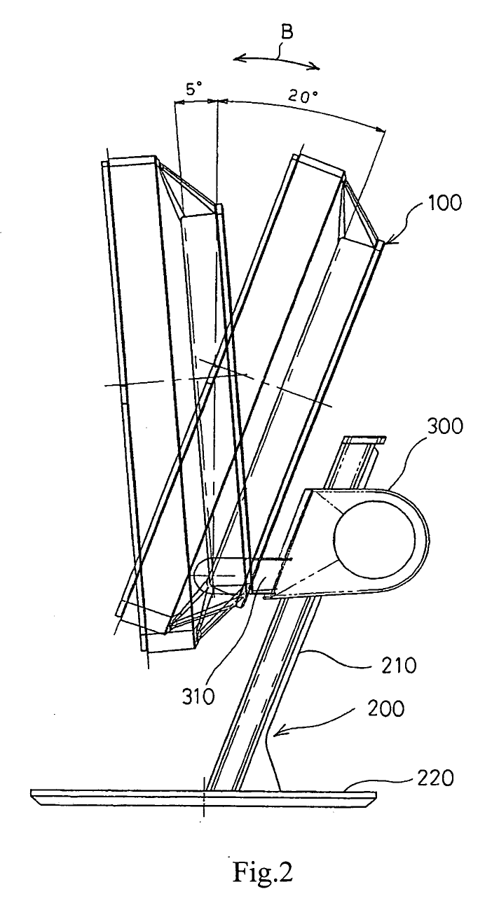

FIGS. 1, 2 are side views showing the appearance of a display apparatus according to an exemplary embodiment of the present invention. FIG. 1 shows moving up and down operation; and FIG. 2 shows tilting movement.

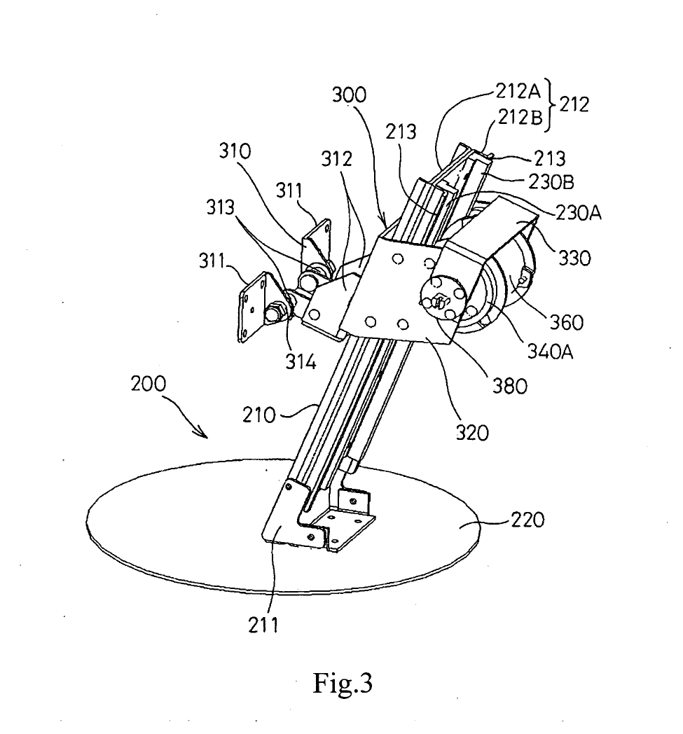

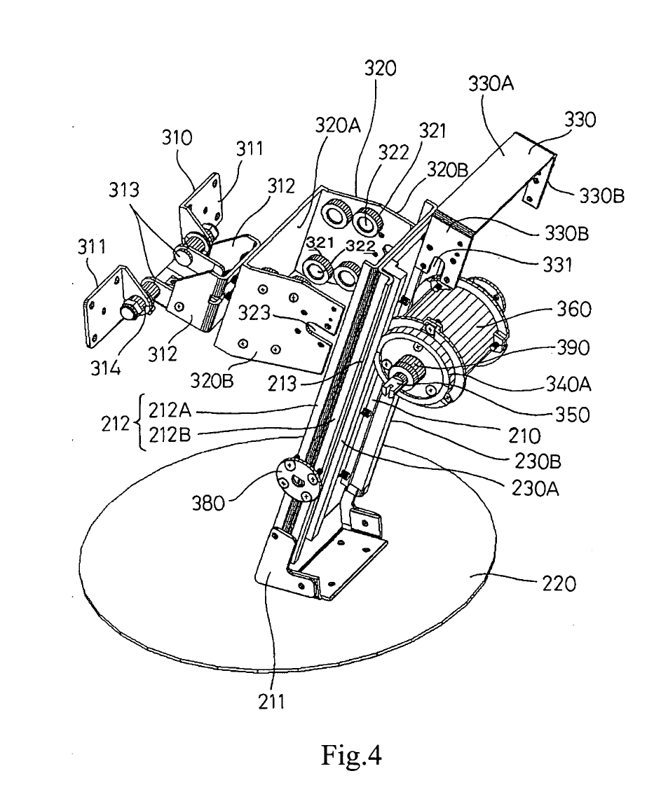

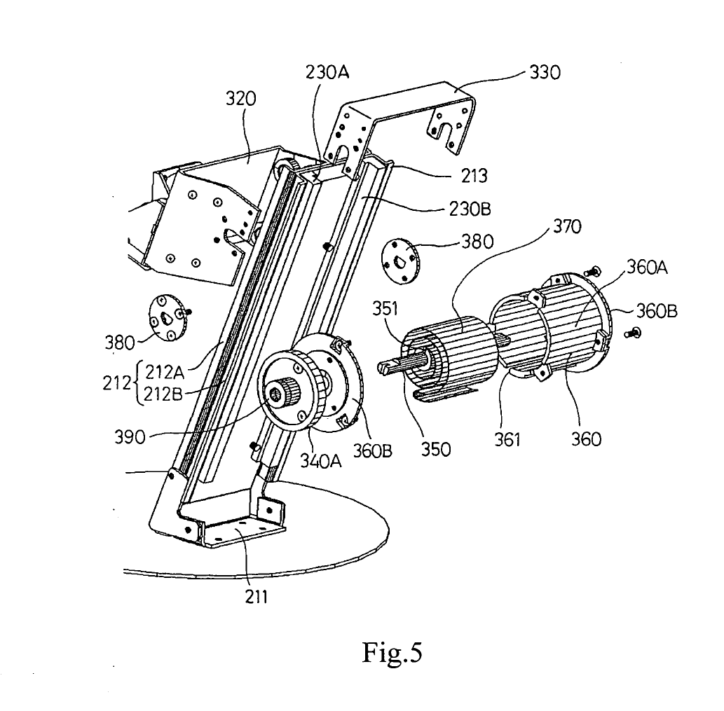

Further, FIGS. 3, 4, 5 are perspective views showing internal structures of the display apparatus according to the present exemplary embodiment. FIG. 3 shows a state in which a post and a slide bracket are coupled together; FIG. 4 shows a state in which the slide bracket is disassembled; and FIG. 5 shows a state in which the interior of the slide bracket is further disassembled.

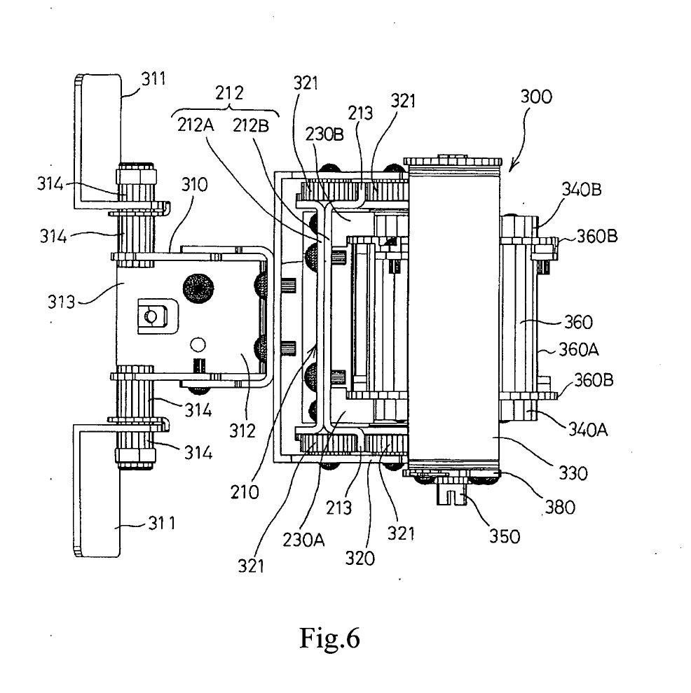

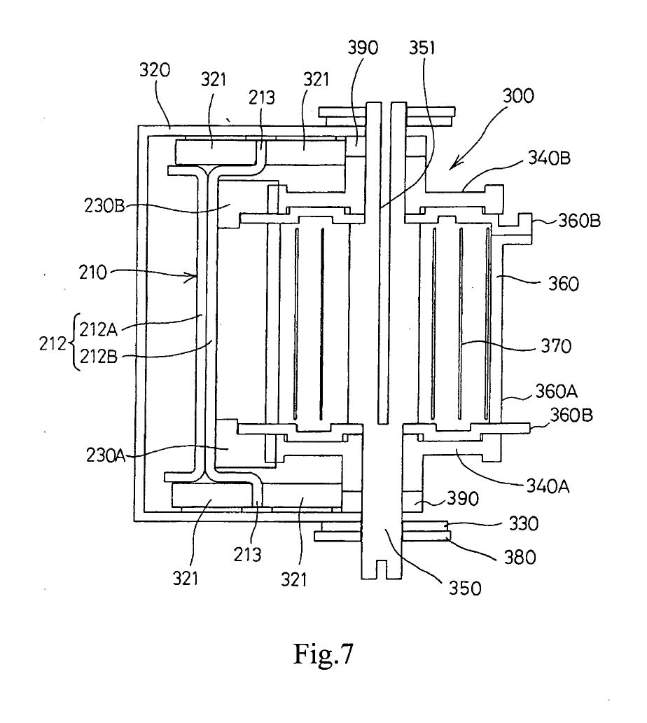

Furthermore, FIGS. 6, 7 are diagrams showing a state in which the post and the slide bracket of the display apparatus according to the present exemplary embodiment are assembled. FIG. 6 is a schematic plan view; and FIG. 7 is a horizontal cross-sectional view of a main part.

As shown in FIGS. 1 and 2, the display apparatus of the present example has a stand section 200 that supports a flat display panel section 100 using, e.g., a liquid-crystal display panel, so as to be height-adjustable and tilt-adjustable.

That is, the display panel section 100 is coupled to a slide bracket 300 via a hinge section 310 disposed therebehind, and this slide bracket 300 is supported by a post 210 of the stand section 200 so as to be slidable in moving up and down directions. Therefore, in this display apparatus, the display panel section 100 is operated to move up and down integrally with the slide bracket 300, whereby the height of the display panel section 100 can be adjusted as shown by arrows A in FIG. 1, and also the display panel section 100 is rotationally moved via the hinge section 310, whereby the angle of the display panel section 100 can be adjusted as shown by arrows B in FIG. 2. Note that the tilting angle is set to, e.g., 5° forward and 200 backward. And these adjustment operations can be performed extremely easily by causing the display panel section 100 to move up and down or tilt through direct gripping of the display panel section 100.

Details of the structure of each of components in the display apparatus of the present example will be described below.

First, the stand section 200 has a disc-shaped base 220 placed on an installation surface such as a desk, the post 210 erected on this base 220, and the slide bracket 300 supported slidably on this post 210.

The base 220 has a size and a weight large enough to support the display panel section 100 in a stable manner. Note that the base 220 is not limited to being disc-shaped, but may otherwise be rectangular plate-shaped.

Further, as shown in FIGS. 3 through 7, the post 210 has a supporting section 211 fixed onto the base 220 with screws, and an arm section 212 fixed onto this supporting section 211 with screws. The arm section 212 is disposed in a manner inclining backwards at a predetermined angle with respect to the base 220, and linearly extending obliquely upwards.

The arm section 212 is formed by bonding two cross-sectionally C-shaped plate members 212A, 212B together back to back, into a post-shaped structure which is substantially H-shaped in horizontal cross-section. Web portions of the cross-sectionally H-shaped structure are disposed in a manner extending in parallel across the width of the display panel section 100.

And, of the two plate members 212A, 212B, the plate member 212B disposed in the rear has both edges thereof outwardly bent to project in a flange-shaped manner, and these projections are formed as guide rails (i.e., a guide section) 213. The slide bracket 300 is assembled so as to be able to move up and down along these rails 213.

Further, on a back surface of the plate member 212B disposed in the rear is a pair of rack members 230A, 230B. The respective rack members 230A, 230B are disposed on both left and right corners of the plate member 212B with rack portions facing rearwards.

The slide bracket 300 has the hinge section 310 for mounting the display section 100 thereon, and a first bracket 320 and a second bracket 330 to be assembled to the post 210.

As shown in FIGS. 3, 4, 6, the hinge section 310 has mounting strips 311 to be screwed to a back surface of the display panel section 100, a mounting strip 312 to be screwed to a front surface of the first bracket 320, and a coupling shaft section 313 for coupling these mounting strips 311, 312 so as to be mutually rotatable.

Frictional rings 314 are set in the coupling shaft section 313. It is configured such that the frictional rings 314 are clamped in axial directions, whereby a predetermined frictional force is imparted to the rotating operations of both strips, and as a result of this frictional force, the display panel section 100 is held with its position adjusted to a predetermined tilting angle.

Note that such a configuration of the hinge section 310 has conventionally been available in various forms, and thus any other configuration may alternatively be adopted as long as it can adjust the tilt of the display panel section 100.

As shown in FIG. 4, the first bracket 320 has a front plate portion 320A disposed on a front surface of the post 210 and side plate portions 320B disposed on both side surfaces of the post 210, and is formed into a U-shaped structure surrounding the post 210 in the front and side regions. The above-mentioned hinge section 310 is coupled to the front plate portion 320A by screwing or the like.

Further, on the inner side of each of the side plate portions 320B of the first bracket 320 are a plurality of rollers 321 that come in rolling contact respectively with both surfaces of a corresponding one of the guide rails 213, and supporting shafts 322 for rotatably supporting these rollers 321. And with the slide bracket 300 assembled to the post 210, each pair of rollers 321 is disposed in a manner interposing the corresponding guide rail 213 therebetween. The respective rollers 321 roll along the guide rails 213, whereby the slide bracket 300 is guided so as to smoothly slide along the guide rails 213 (i.e., the post 210).

Further, in rear edge portions of the side plate portions 320B of the first bracket 320, notches 323 are provided to which a shaft 350 that supports gears 340A, 340B described later is to be attached.

Further, the second bracket 330 is coupled, behind the post 210, to the rear edge portions of the side plate portions 320B of the first bracket 320, to reinforce the first bracket 320. Side plate portions 330B are provided on both sides of a longitudinal extending plate-shaped upper plate portion 330A so as to overlap the rear edge portions of the side plate portions 320B of the first bracket 320. And, in lower edge portions of the side plate portions 330B of the second bracket 330,notches 331 are provided to which the shaft 350 that supports the gears 340A, 340B is to be attached.

Note that the notch 323 in each of the side plate portions 320B of the first bracket 320 and the notch 331 in the corresponding one of the side plate portions 330B of the second bracket 330 form a single attachment hole with one overlapping the other.

Next, to the slide bracket 300 such as described above, there are assembled, as shown in FIGS. 5 through 7, the gears 340A, 340B, the shaft 350, a drum (cover body) 360, a spiral spring 370, and the like, behind the post 210.

The shaft 350 has both ends thereof fastened to the attachment holes formed from the above-mentioned respective notches 323, 331 in the side plate portions 320B of the first bracket 320 and in the side plate portions 330B of the second bracket 330, via fixing members 380 and the like, to be integrally fixed onto the slide bracket 300.

Note that the fixing members 380 have fitting holes that allow cross-sectionally semicircular portions formed at both end portions of the shaft 350 to be fitted thereinto, whereby the fixing members 380 are coupled to the shaft 350 while blocking the rotation of the shaft 350. Further, while each of these fixing members 380 is screwed to the slide bracket 300 using a plurality of screws, each of screw insertion holes in this portion is provided with a predetermined clearance, and taking advantage of these clearances, the angle of the shaft 350 can be finely adjusted and the winding condition of the spiral spring 370 can be finely adjusted. That is, with set screws for the fixing members 380 loosely tightened tentatively, the shaft 350 is slightly turned through a groove formed in an end portion of the shaft 350 using a screwdriver or the like, and thereafter the set screws are strongly tightened to firmly fix the shaft 350 and the fixing members 380. Note that at the time of the tentative tightening, it is designed to use a clip or the like, not shown, in order to prevent rattle during fine adjustment to enhance the operability.

The gears 340A, 340B are fitted through and supported by the shaft 350 fixed to the slide bracket 300, and the drum 360 is provided so as to rotate integrally with the gears 340A, 340B.

The gears 340A, 340B are disposed in pairs on both left and right sides of the post 210 in a manner corresponding to the rack members 230A, 230B, and mesh with the rack members 230A, 230B, respectively, to rotate in linkage with moving up and down the slide bracket 300.

Further, the drum 360 is disposed between both gears 340A, 340B coaxially therewith, and has flanges 360B on both ends of a circular drum body 360A. The respective gears 340A, 340B are screwed to these flanges 360B, whereby the drum 360 is integrated with the gears 340A, 340B.

Furthermore, the spiral spring 370 is accommodated within the drum 360 in a wound state, has one end thereof (an outer end portion) locked into a locking groove 361 provided in the drum 360, is wound around the shaft 350, and has the other end thereof (an inner end portion) locked into a locking groove 351 (see FIG. 7) formed in the shaft 350.

Note that the winding direction of the spiral spring 370 varies such that the spiral spring 370 is wound tightly when the gears 340A, 340B rotate in such a direction as to cause the slide bracket 300 to move down, to impart resiliency to the gears 340A, 340B.

Therefore, the spring force of the spiral spring 370 acts as a biasing force for causing the slide bracket 300 to ascend through its biasing the gears 340A, 340B to rotate, whereby easy operability is realized when a user operates the display panel section 100 to move up. Note that by making the number of its turns large enough (e.g., ten turns or more), the spiral spring 370 can keep its biasing force to be applied to the slide bracket 300 substantially constant during the moving up and down strokes of the slide bracket, and thus stable and smooth operability can be obtained.

Frictional rings 390 (see FIG. 7) are set into gaps between the gears 340A, 340B and the slide bracket 300, respectively, and when the frictional rings 390 are clamped in axial directions, predetermined frictional forces are imparted to the rotating operations of the gears 340A, 340B. And as a result of these frictional forces, the rotation of the gears 340A, 340B is suppressed to have the display panel section 100 (slide bracket 300) held (stay) at an arbitrary height after an adjustment operation. Note that due to the relationship between the dynamic friction coefficient and the static friction coefficient, the frictional forces of the frictional rings 390 become weak during height adjustment of the display panel section 100, to permit smooth moving up and down operation.

In the display panel having a configuration such as described above, when the display panel section 100 is grasped and operated to move up and down or tilt, various mechanical components provided in the stand section 200 follow the operation, whereby simple adjustment of the display panel section 100 to a desired height or tilting angle is possible, and hence easy operability can be obtained.

Particularly, as a result of the configuration in which the slide bracket 300 is slidably moved along the linear guide structure, extremely smooth operation can be obtained, whereby a stand structure with a little breakdown or the like can be provided.

Furthermore, internal structures such as the spiral spring 370 are concealed inside the slide bracket 300, whereby a structure excellent even in appearance can be realized.

While, in the above example, it is configured such that the shaft 350 of the gears 340A, 340B is fixed and the drum (cover body) 360 rotates integrally with the gears 340A, 340B, with the spiral spring 370 set therebetween, a structure can otherwise be implemented in which the shaft 350 rotates and the cover body 360 is fixed, with the spiral spring 370 set therebetween. Further, such a setting structure of the spiral spring 370 may variously be adaptable, and thus can be modified suitably.

Further, the shape of the rack members 230A, 230B and the gears 340A, 340B can also be modified suitably. For example, a pair of rack members and a pair of gears may be provided, or, for example, a rack member and a gear, both of which are large in width, may alternatively be provided.

Furthermore, specific structures of the above-described exemplary embodiment, e.g., the fixed structure of the shaft, the specific structure of the slidebracket, the friction means, and the like can be modified variously, and can be adopted suitably within the scope and spirit of the present invention.

### INDUSTRIAL APPLICABILITY

As described in the foregoing, the display apparatus of the present invention has a structure in which a slide bracket is assembled to a post having a linear guide section to mesh rack members provided on the side of the post with gears provided on the side of the slide bracket, a spiral spring is provided between the gears and the slide bracket, the spiral spring is provided to impart a biasing force to the gears such that the gears rotate in such a direction as to cause the slide bracket to ascend, and a cover body for accommodating this spiral spring therein is provided. Accordingly, height adjustments and tilting angle adjustments of the display panel section can be made smoothly, and hence a stand structure excellent in operability as well as appearance can be provided.

1. A display apparatus, including:
a flat display panel section; and
a stand section for supporting the display panel section; wherein the stand section is characterized by comprising:
a base placed on an installation surface;
a post provided to stand on the base and linearly extending substantially upwards;
a rack member provided on the post in a post extending direction;
a slide bracket coupled to a back surface of the display panel section via a hinge section, and also coupled to the post to move upland down freely so as to be able to move up and down along the post;
a gear mounted on the slide bracket and meshing with the rack member to rotate in linkage with the slide bracket moving up and down along the post;
friction means for imparting a frictional force to a rotating operation of the gear so as to hold the slide bracket at an arbitrary height of the post;
a spiral spring having one end thereof locked to a gear side to be disposed in a state wound around a rotational center of the gear facing in a horizontal direction, and other end thereof locked to a slide bracket side so that the wound state thereof is changed in accordance with rotation of the gear to impart a biasing force to the gear in a rotating direction to cause the slide bracket to move up; and
a cover body mounted onto the slide bracket or the gear to accommodate the spiral spring therein.

2. The display apparatus according to claim 1, characterized in that;
the post comprises a guide section extending along the post extending direction; and
the slide bracket is movably coupled to the guide section.

3. The display apparatus according to claim 1, characterized in that:
the rack member is provided on a back surface of the post positioned on a side opposite to the display panel section; and
the gear is disposed behind the post to face the rack member.

4. The display apparatus according to claim 1, characterized in that:
the gear is disposed rotatably on a shaft extending in a horizontal direction and unrotatably supported by the slide bracket; and
the spiral spring is wound around the shaft and has one end thereof locked to a gear side and other end thereof locked into the shaft.

5. The display apparatus according to claim 1, characterized in that:
the gear is disposed rotatably on a shaft extending in a horizontal direction and unrotatably supported. by the slide bracket;
the cover body is formed into a cylindrical shape coaxial with the shaft to have an end portion thereof attached to the gear; and
the spiral spring is wound around the shaft, and has one end thereof locked into the cover body and other end thereof locked into the shaft.

6. The display apparatus according to claim 1, characterized in that:
the rack member is disposed in pairs on both left and right sides of a back surface of the post positioned on a side opposite to the display panel section;
the gear is disposed in pairs so as to correspond to the pair of rack members;
the pair of gears is disposed rotatably on a shaft unrotatably supported by the slide bracket and extending in a horizontal direction;
the cover body is formed into a cylindrical shape coaxial with the shaft, and disposed between the pair of gears with both ends thereof attached to the pair of gears, respectively; and
the spiral spring is wound around the shaft between the pair of gears with one end thereof locked into the cover body and other end thereof locked into the shaft.

7. The display apparatus according to claim 1, characterized in that:
the guide section has guide rails respectively formed on both left and right side portions of the post; and
the slide bracket has a plurality of rollers coming in rolling contact with the guide rails;
wherein the moving up and down of the slide bracket is guided by rolling of the rollers along the guide rails.
